(19) United States
(12) Patent Application Publication
(10) Pub. No.: US 2025/0199515 A1
(43) Pub. Date: Jun. 19, 2025

(54) CREATION AND/OR MODIFICATION OF FUNCTIONAL UNITS

(71) Applicant: Analytik Jena GmbH+Co. KG, Jena (DE)

(72) Inventor: Lars Böttcher, Melsungen (DE)

(21) Appl. No.: 18/981,878

(22) Filed: Dec. 16, 2024

(30) Foreign Application Priority Data
Dec. 15, 2023 (DE) 10 2023 135 369.1

(51) Int. Cl. G05B 19/4155

(52) U.S. Cl. CPC G05B 19/4155; G05B 2219/31368

(57) ABSTRACT

The present disclosure discloses a method for creation and/or modification of functional units and/or implementation plans. Users are provided a communication channel and in addition transferred data are processed and an identification result produced. Starting from the identification result, nonexisting functional units are produced and/or properties of existing functional units modified and/or nonexisting implementation plans are produced and/or existing implementation plans modified. Furthermore, the present disclosure relates to a platform.

### CROSS-REFERENCE TO RELATED APPLICATION

The present application is related to and claims the priority benefit of German Patent Application No. 10 2023 135 369.1, filed on Dec. 15, 2023, the entire contents of which are incorporated herein by reference.

### TECHNICAL FIELD

The present disclosure relates to a method for creation and/or modification of functional units for a modular plant for handling and/or analysis of a sample and/or functional units for a modular plant of process and automation technology and/or for creation and/or modification of implementation plans, which describe an implementation of analysis- and/or processing protocols in modular plants. Furthermore, the present disclosure relates to a platform for performing the method.

### BACKGROUND

In modern technology, the trend is always greater in the direction of modularity, for enabling an optimum individualizing and facilitated replacement of components and modules. The thinking relative to modularity extends, in such case, also to large and complex analysis- or process plants, which, in each case, are broken down into individual functional units. For this, suitable modules must be available.

Furthermore, a trend is that users are always more and more interested themselves to reign over plants or processes and themselves to select the required modules. This can result e.g. from the fact that then protocols, which are to be implemented e.g. in a plant of functional units, do not need to be disclosed to a plant builder. For this, data needs to be suitably made available to the user, such that the user can itself do the planning of a plant.

The autonomy of the user can, however, lead to the fact that a manufacturer of modules does not optimally possess knowledge of the requirements and problematics of users. Therefore, it can happen that necessary modules do not exist or that existing modules for applications are in need of improvement, without the manufacturer knowing such. Similar considerations hold for the idea that the manufacturer might be able to suggest suitable modules and, consequently, make the planning of a plant easier.

### SUMMARY

An object of the present disclosure is, consequently, to provide for an effective information flow between users and manufacturers of components of plants.

The present disclosure solves the object by a method for creation and/or modification of functional units for a modular plant for handling and/or analysis of a sample and/or of functional units for a modular plant of process and automation technology and/or for creation and/or modification of implementation plans describing implementation of analysis- and/or processing protocols in modular plants, wherein the method comprises steps as follows: providing users at least one communication channel for transferring data, processing data transferred over the communication channel and producing an identification result indicating whether functional units do not exist and/or whether properties of existing functional units should be modified and/or whether implementation plans do not exist and/or whether existing implementation plans should be modified, and, based on the identification result, manufacturing nonexisting functional units and/or modifying properties of existing functional units and/or producing nonexisting implementation plans and/or modifying existing implementation plans.

Examples of functional units could, thus, generally be modules or components applied in plants for examining and/or preparing samples or applied in plants of processing and automation technology.

The method serves, depending on embodiment, for manufacturing and/or modifying functional units for a modular plant for handling and/or analysis of a sample (this would comprise, in such case, the field of robotics, in order e.g. to move a sample). Alternatively or supplementally, the method serves for manufacturing and/or modifying functional units for a modular plant of process and automation technology. Alternatively or supplementally, the method serves for producing and/or modifying implementation plans describing implementation of analysis- and/or processing protocols in modular plants. Application resides, thus, for example, in the laboratories field as part of life sciences or pharmacy. Application can be, however, part of monitoring or controlling process variables within a process plant.

In the method of the present disclosure, users are offered communication channels. Therewith, users can communicate with one another or also e.g. with a provided platform.

Data are transferred via the communication channels. The data concern e.g. properties of functional units, arrangement of functional units with one another, protocols executed with functional units or executed in plants formed of functional units, or e.g. also questions or challenges confronting the users. The communication channels allow e.g. mail-, chat-, video- or telephonic communication. For example, a communication channel is available after reaching a homepage. Alternatively or supplementally, a communication channel unfolds, for example, upon the accepting of an invitation for an audio/video conference or a social media platform.

The data, which can, thus, contain the most varied of information, are processed e.g. by a superordinated unit, which is, for example, part of the platform. The processing produces an identification result. The result concerns identifying, whether a functional unit does not exist or whether an existing functional unit should be modified in at least one property or whether an implementation plan does not exist or whether an existing implementation plan is in need of modification. An implementation plan describes, in such case, how a protocol is implemented for the analysis- and/or processing of samples in a plant. Of concern is, thus, virtually, a kind of construction plan for a plant, in which the protocol is executed. The implementation plan can, in such case, be differently granular, such that it contains in one variant only a listing of the applied functional units and includes in another variant also the arrangements of the functional units relative to one another.

Examples of functional units, or of functions to be implemented by the units, include: pipetting head; reader; magnet stations; storage systems; washer; pump modules; heater; cooler; shaking device; thermocycler; dispenser; waste management; consumables producing units; sample taker; sample collector; autosampler; robot; carrier; compressor; sealer; peeler; piercer; scale; incubators; centrifuges; vacuum stations; labeling machine; 3D-printer; microscopes; decontamination; illumination system; radiation probe; cleaning system (washing line); charging stations for carrier (for example, via an inductive charging); “power stations” with the opportunity to utilize a plurality of electrical current circuits, in order, in given cases, to guarantee against shut down, wherein, in given cases, a distribution to different functional units takes place: interruptionless electrical power supply (IPS) modules as failsafe for operation of a plant for a predetermined period of time; communication modules (e.g. for communication via WLAN, Bluetooth etc.); implementation of safe and, in given cases, redundant communication between individual functional units; communication units for, in given cases, tapping or hacking secure communication with external units (in given cases, as part of communication with a manufacturer); monitor module (with or without touch-function; with or without input-opportunity); monitor module with a removable display unit and/or charging unit such as e.g. a rechargeable battery; control module for selecting and/or starting workflows directly at the plant; modules for securing and/or operating an exhaust system.

An embodiment provides that a plurality of communication channels are provided. The communication channels can serve, in such case, depending on embodiment, for communication between users and/or between a platform and a user or, in given cases, between a plurality of users.

An embodiment includes that a communication channel is provided in such a manner that a user can upload data to a platform, such that the data is available for other users. The user, thus, in this embodiment uploads its own or self processed data to a platform. Additionally, the user provides this data free for other users. The user, thus, makes its data and its information available for other users.

The opportunity for uploading and releasing data is supplemented in an embodiment by providing that when data uploaded by a user to the platform is accessed by another user, the uploading user receives a payment. In this embodiment, a user, thus, has an incentive to make its data freely available. Via this, a user is also motivated to provide data for themes of general interest, for, in this way, the user increases the probability that other users will access its data.

In an additional, supplementing or alternative embodiment, a user is offered an incentive for uploading its data, in that the number of cases in which data uploaded by a user to the platform is accessed by other users is logged, and, when the number of cases exceeds a predetermined limit value, the user is given a commendation. The user obtains, thus, e.g. an award, when many users find its data to be of interest and are animated to access such.

According to one embodiment, the communication channel is provided in such a manner that a user makes available via the communication channel use data with reference to a use of a plant. In this embodiment, it is taken into consideration that a user already has experience with a plant having preferably at least one functional unit. Use data result from use of the plant and/or the functional unit. The use data comprise e.g. the length of time of operation, or conditions, to which the plant was exposed (e.g. temperature, moisture, in given cases, loss of electrical current supply, cleaning processes, etc.). Alternatively or supplementally, also more comprehensive data can be involved. If, for example, the plant serves for processing or handling substances, for which consumable articles or consumable materials are necessary, then the use data concern, for example, the time period, after which the consumable articles or consumable materials must be replenished. Other use data concern, for example, information about the plant per se. The different use data are provided by the user via the communication channel. In a variant, the user actively transfers use data e.g. to a platform. In an alternative or supplementing variant, the user enables the accessing of use data, in that e.g. the platform can access the use data or a (released) part of the use data. The use data allow, for example, determining with which functional units or with which modified functional units the user could operate its plant more effectively.

Another embodiment provides that a platform provides users with data concerning existing functional units and/or implementation plans. Thus, the users can, in this embodiment, preferably via the provided communication channels, retrieve from the platform data describing already existing functional units or already existing implementation plans. The user obtains, thus, information, starting from which its own data can be produced or modified.

An alternative or supplementing embodiment provides that a user is offered at least one suitable implementation plan as a function of a protocol. In this embodiment, the user transfers, for example, an analysis- and/or processing protocol to a platform. In the platform, it is detected, whether there is for this protocol already an identical or at least with sufficient similarity fitting implementation plan, or a fitting implementation plan is generated. This plan is then provided to the user.

In a further embodiment, in the case where a user has uploaded an implementation plan to a platform, an implementability of the implementation plan is ascertained with respect to existing functional units and/or with respect to modifiable functional units and/or with respect to functional units to be built new. In the case of this embodiment, thus, the question is whether an implementation plan can be formed with existing functional units or with modified functional units or only with newly made functional units and whether new functional units are really possible. Thus, a kind of feasibility study is performed. This evaluation can occur, alternatively, at the user, e.g. in a configuration tool during the creation of the implementation plan. The result of ascertaining the implementability is preferably reported to the user. Alternatively or supplementally, optimizations of the implementation plan are done.

In an alternative or supplementing embodiment, when data transferred by the users via the communication channel contains information concerning existing functional units, users are given information concerning a source of supply. The information concerning the source of supply can be e.g. a link to an Internet shop.

Furthermore, the present disclosure achieves the object by a platform providing users at least one communication channel for transferring data and embodied in such a manner that it executes the method according to one of the preceding or following embodiments. The explanations for the method hold correspondingly also for the platform. Conversely, explanations and embodiments of the platform hold correspondingly also for the method.

### BRIEF DESCRIPTION OF THE DRAWINGS

The present disclosure will now be explained in greater detail based on the appended drawing, the figures of which show as follows:

FIG. 1 schematically, an environment, in which the method is applied,

FIG. 2 schematically, the processing of data,

FIG. 3 schematically, a plant of the field of analysis, and

FIG. 4 schematically, an application in the field of process and automation technology.

### DETAILED DESCRIPTION

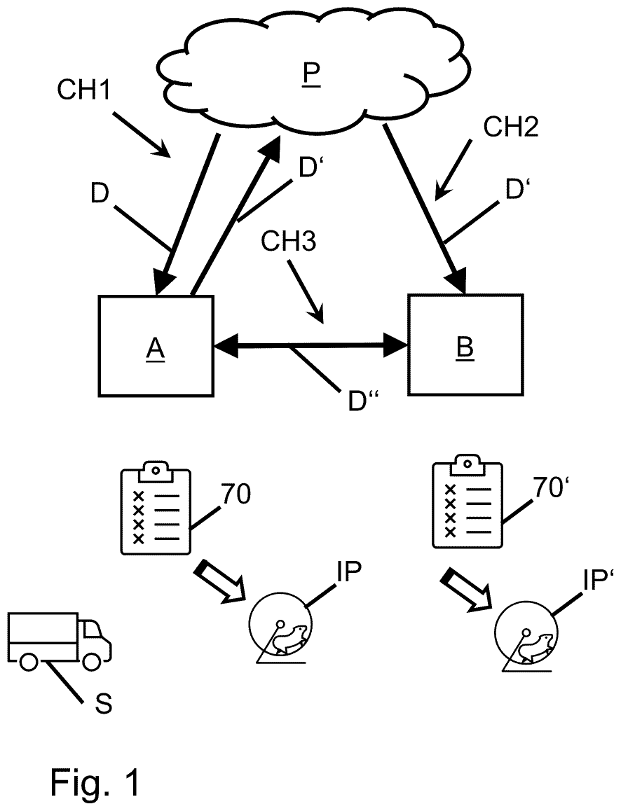

FIG. 1 shows, schematically, how three communication channels CH1, CH2, CH3 are provided by a platform P. Two channels CH1, CH2 serve, in such case, for communication back and forth between the platform P and two users A, B. The third channel CH3 enables communication between users A, B.

User A downloads data D from the platform P, modifies it according to its needs and uploads it as changed data D′ to the platform P. The other user, user B, accesses this data D′, in given cases, cleansed of personal data of the user A or reformatted, etc., and downloads it over its channel CH2.

The two users A, B, over there own communication channel CH3, exchange data D″, e.g. concerning their use cases or the functional units used by them. In this example, each user would be interested in converting a protocol 70, 70′ into an implementation plan IP, IP′. The implementation plan IP, IP′ includes, in each case, the functional units (alternative names: components or modules) needed for execution of the protocols 70, 70′ and, in given cases, also arrangements of the functional units relative to one another.

In the example, e.g., the communication with the data D″ exchanged between users A, B has led to the fact that user B has detected that for its protocol 70′ it preferably accesses the data D′, which the other user A produced with respect to its protocol 70 and uploaded to the platform P. The two users A, B have, thus, talked with one another, for example, regarding similarities of or differences between their protocols 70, 70′.

The protocols, e.g. analysis- and/or processing protocols, 70, 70′ concern, in such case, quite generally, the course of events in the analysis and processing of samples in the respective plants.

Additionally, the environment of the method in such case also includes a source S of the functional units. Such is, for example, the manufacturer or a wholesaler. Accessing such occurs, for example, via the Internet or via an Internet shop.

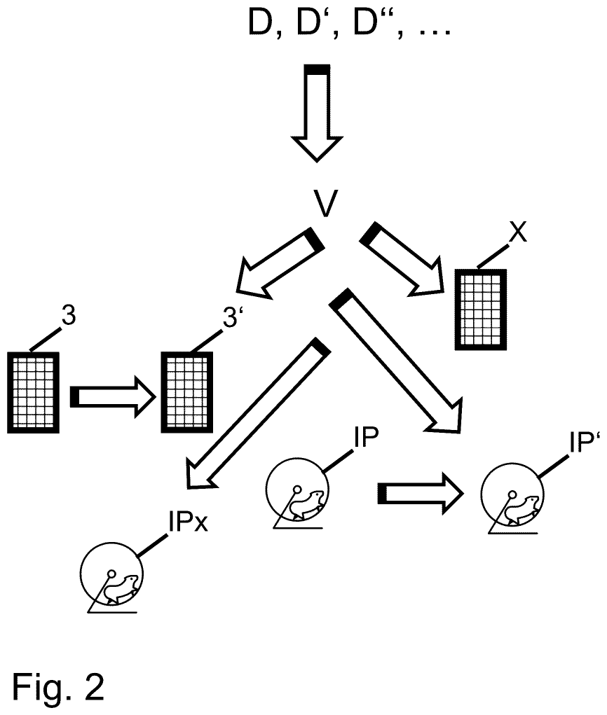

FIG. 2 illustrates how the data D, D′, D″ are evaluated, in order to produce an identification result IR.

There, it is, per case, detected, whether a functional unit 3 is to be modified to provide a modified functional unit 3′. The modification concerns e.g. dimensions, accessibilities, accuracies, options for cleaning, opportunity for connecting with other functional units, etc.

It can, however, also be detected that a new functional unit X should be manufactured. Other findings concern implementation plans, such that e.g. a modified implementation plan IP′ is produced from an existing implementation plan IP. Or it can be detected that for a protocol or a group of protocols a new implementation plan IPx should be produced. The protocols concern e.g. the analysis of blood or gene analysis.

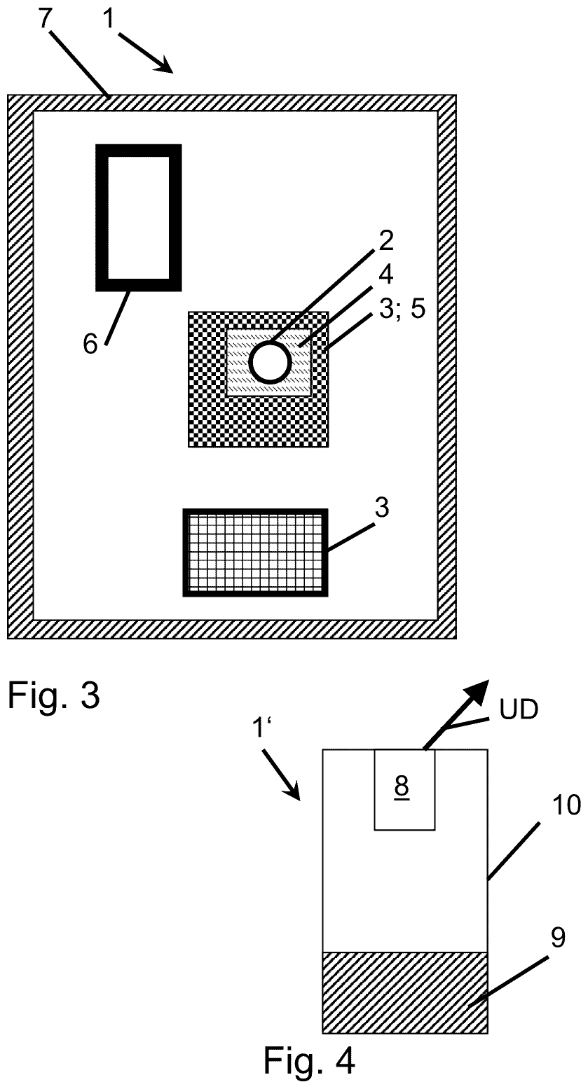

FIG. 3 shows schematically a plant 1, in which samples 2 are handled.

The examination is composed, in such case, e.g. of a preparing, a cleaning, an elutriation, a splitting into components, and a following examination, e.g. in the form of an analysis, whether a certain substance is present in the sample 2. Preferably, the plants 1 are, however, plants for analysis of samples 2. Depending on size or functionalities, plant 1 can alternatively also be referred to as a device or apparatus.

The handling of the sample 2 occurs according to a protocol 70, in which e.g. the individual handling steps, including, e.g. also preparatory or subsequent steps, e.g. for a cleaning, are performed with the sample. The individual steps are, in such case, associated with functional units 3, which execute the steps as functions or which interact with other functional units 3, in order to support the other functional units 3.

Thus, if e.g. a sample 2 must first be filtered, then a functional unit 3 is embodied as a filter. For a temperature control of the sample 2, a heating- or cooling unit can be present as a functional unit 3. Finally, a functional unit 3 can also be embodied as an analytical unit, e.g. as a mass spectrometer. In such case, the other functional units 3 would serve e.g. for the preparation of the sample 2 for the analysis.

The implemented plant 1 is, thus, composed of a plurality of functional units 3. Three special groups of the functional units 3 are indicated in such case, as transport unit 4, as base unit 5 and as storage unit 6 for the sample 2. The transport unit 4 moves in such case, the sample 2 over the base unit 5 through the plant 1 and brings it, thus, from one functional unit 3 to another. The functional units 3, 4, 5, 6 are, in such case, situated in a structural means 7, e.g. in the form of a cabinet.

FIG. 4 shows a plant 1′ of the field of process and automation technology.

In such case, a functional unit 8 in the form of a sensor using the travel time method monitors the fill level of a fill substance 9 in a container 10. Resulting from the operation of the sensor 8 are use data UD, which concern e.g. the active time of the sensor 8, the measured values, the energy supply or e.g. the measuring conditions (ambient temperature, humidity, etc.).

1. A method for creation and/or modification of functional units for a modular plant for handling and/or analysis of a sample and/or of functional units for a modular plant of process and automation technology and/or for creation and/or modification of implementation plans describing implementation of analysis- and/or processing protocols in modular plants, wherein the method comprises steps as follows:
providing users at least one communication channel for transferring data,
processing data transferred over the communication channel and producing an identification result indicating whether functional units do not exist and/or whether properties of existing functional units should be modified and/or whether implementation plans do not exist and/or whether existing implementation plans should be modified, and,
based on the identification result, manufacturing nonexisting functional units and/or
modifying properties of existing functional units and/or producing nonexisting implementation plans and/or modifying existing implementation plans.

2. The method as claimed in claim 1,
wherein a plurality of communication channels are provided.

3. The method as claimed in claim 1,
wherein a communication channel serves for communication between users.

4. The method as claimed in claim 1,
wherein a communication channel serves for communication between a platform and a user.

5. The method as claimed in claim 1,
wherein the communication channel is provided in such a manner that a user can upload data to a platform, such that it is available for other users.

6. The method as claimed in claim 5,
wherein when data uploaded by a user to the platform is accessed by another user, user receives a payment.

7. The method as claimed in claim 5,
wherein the number of cases in which data uploaded by a user to the platform is accessed by other users is logged, and, when the number of cases exceeds a predetermined limit value, the user is given a commendation.

8. The method as claimed in claim 1,
wherein the communication channel is provided in such a manner that a user makes available via the communication channel use data with reference to a use of a plant.

9. The method as claimed in claim 1,
wherein a platform provides users with data concerning existing functional units and/or implementation plans.

10. The method as claimed in claim 1,
wherein a user is offered at least one suitable implementation plan as a function of a protocol.

11. The method as claimed in claim 1,
wherein when a user has uploaded an implementation plan to a platform, an implementability of the implementation plan is ascertained with respect to existing functional units and/or with respect to modifiable functional units and/or with respect to functional units to be built new.

12. The method as claimed in claim 1,
wherein when data transferred by users via the communication channel contains information concerning existing functional units, users are given information concerning a source of supply.

13. A platform,
wherein the platform provides users at least one communication channel for transferring data and wherein the platform is embodied in such a manner that it executes the following method:
providing users at least one communication channel for transferring data, processing data transferred over the communication channel and producing an identification result indicating whether functional units do not exist and/or whether properties of existing functional units should be modified and/or whether implementation plans do not exist and/or whether existing implementation plans should be modified, and,
based on the identification result, manufacturing nonexisting functional units and/or modifying properties of existing functional units and/or producing nonexisting implementation plans and/or modifying existing implementation plans.
